(19) United States
(12) Patent Application Publication
(10) Pub. No.: US 2026/0218545 A1
(43) Pub. Date: Jul. 30, 2026

(54) VEHICLE DOOR LATCH AND ASSOCIATED METHOD

(71) Applicant: Minebea AccessSolutions France, Alfortville (FR)

(72) Inventors: Jerry GODARD, Alfortville (FR); Johann ROBERT, Alfortville (FR); Benoit FRANKE, Alfortville (FR)

(73) Assignee: Minebea AccessSolutions France, Alfortville (FR)

(21) Appl. No.: 19/449,797

(22) Filed: Jan. 15, 2026

(30) Foreign Application Priority Data
Jan. 28, 2025 (EP) 25315024

(51) Int. Cl. E05B 79/02; E05B 81/06; E05B 81/54

(52) U.S. Cl. CPC E05B 79/02; E05B 81/06; E05B 81/54

(57) ABSTRACT

A vehicle door latch for closing a vehicle door includes a housing, an electrical component arranged at least partially within the housing, a connector arranged at an edge of the housing and able to be linked to a power supply of the electrical component, and a leadframe arranged within the housing and linking the connector and the electrical component. The housing includes at least one recess and the leadframe includes at least one deformable part complementary with the recess of the housing and able to be inserted within the recess of the housing to secure the leadframe to the housing. The deformable part has a larger width than the width of the recess such that the deformable part is deformed when inserted within the recess.

### TECHNICAL FIELD

The present invention relates to the field of vehicle door latches to ensure the closing of vehicle doors. In particular, the invention relates to vehicle door latches comprising an electrical mechanism. The present invention also refers to an assembling method of the vehicle door latch.

### BACKGROUND OF THE INVENTION

It is well known to provide vehicle door latches with an electrical component such as an electrical motor, for example to provide an electrical release of the latch and an electrical closure of the door. It is also well known to use a leadframe to supply the electrical components. The leadframe is generally surrounding by a housing in order to prevent a short circuit and to protect the leadframe. The housing is also used to hold the leadframe in position to prevent a disconnection between the leadframe and the electrical components. The leadframe needs therefore to be secured to the housing tightly enough to prevent vibrations of the vehicle from disassembling the leadframe from the housing. To achieve such securing, a method of the state of the art refers to the use of tabs arranged in the housing (the tabs may be part of the housing) and configured to be deformed to hook on the leadframe and to ensure a reliable tightening between the housing and the leadframe. The tabs may be heated to allow their deformation (hot stacking technique).

Such securing step appears therefore to be time consuming as it requires several operations to deform the different tabs. Furthermore, in case of a hot stacking technique, it requires a heat source and is therefore power consuming.

It is therefore an aim of the present invention to overcome at least partially the drawbacks of the prior art and to provide a simple and economic solution to reliably secure a leadframe of a vehicle door latch to a housing.

### SUMMARY OF THE INVENTION

The present invention refers to a vehicle door latch for closing a vehicle door, comprising:
a housing,
an electrical component arranged at least partially within the housing,
a connector arranged at an edge of the housing and configured to be linked to a power supply of the electrical component,
a leadframe arranged within the housing and linking the connector and the electrical component,
   wherein the housing comprises a recess and the leadframe comprises a deformable part complementary with the recess of the housing and configured to be inserted within the recess of the housing to secure the leadframe to the housing, the deformable part having a larger width than the width of the recess such that the deformable part is deformed when inserted within the recess.

The use of a housing with a recess and a leadframe with a deformable part configured to be introduced within the recess and to be deformed when inserted in the recess enables a reliable securing of the leadframe to the housing without requiring numerous and tedious securing steps.

According to an embodiment of the present invention, the deformable part is in one piece with the leadframe.

According to an embodiment of the present invention, the deformable part is configured to deform elastically when inserted within the recess.

According to an embodiment of the present invention, the recess comprises an opening with a convergent shape to ease the insertion of the deformable part within the recess.

According to an embodiment of the present invention, the deformable part has a V-shape with a first arm and a second arm linked by a proximal end wherein at least one arm is configured to be bent towards the other arm to reduce the width of the deformable part when introduced within the recess.

According to an embodiment of the present invention, the distal end of the first arm and the second arm of the deformable part has a sharp shape configured to hook on the wall of the recess when the deformable part is inserted in the recess.

According to an embodiment of the present invention, the leadframe is made of copper (CuZn or steel) or of platted alloy.

According to an embodiment of the present invention, the housing is made of plastic material.

According to an embodiment of the present invention, the electrical component is an electrical motor.

According to an embodiment of the present invention, the deformable part is configured to be slid within the recess and wherein the leadframe also comprises a leg configured to provide a pushing zone to allow the sliding of the leadframe.

According to an embodiment of the present invention, the leadframe comprises a plurality of deformable parts distributed across the leadframe and the housing comprises a plurality of recesses configured for receiving respectively the plurality of deformable parts.

The present invention also refers to a method for assembling a vehicle door latch as described previously, the method comprising the following steps:
providing a housing with at least one recess and a leadframe with at least one complementary deformable part,
positioning the leadframe next to the housing so that the at least one deformable part is located respectively in front of an opening of the at least one recess,
sliding laterally the leadframe to insert the at least deformable part respectively into the at least one complementary recess,
arranging the at least electrical component in contact with the leadframe.

### BRIEF DESCRIPTION OF THE DRAWINGS

FIG. 1 is a perspective view of a portion of a vehicle door latch according to an embodiment

of the present invention;

FIG. 2 is a perspective view of a portion of a leadframe assembled to the housing according to an embodiment of the present invention;

FIG. 3 is a perspective view of a portion of the leadframe of FIG. 2 during assembly to the housing;

FIG. 4 is a perspective view of a deformable part of a leadframe according to an embodiment of the present invention;

FIG. 5 is a perspective view of a portion of a leadframe comprising a plurality of deformable parts;

FIG. 6 is a perspective top view of a deformable part of a leadframe located at the opening of a recess of a housing;

FIG. 7 is a perspective side view of a deformable part of a leadframe inserted in a recess of a housing;

FIG. 8 is a perspective top view of a deformable part of a leadframe during a first phase of the insertion within a recess of a housing;

FIG. 9 is a perspective top view of a deformable part of a leadframe during a second phase of the insertion within a recess of a housing;

FIG. 10 is a perspective top view of a deformable part of a leadframe inserted in a recess of a housing;

FIG. 11 is a flowchart of the steps of a method for assembling a vehicle door latch according to an embodiment of the present invention.

In these figures, the identical elements have the same reference numbers. Only the elements necessary for the understanding of the invention are shown.

### DETAILED DESCRIPTION OF THE INVENTION

The following embodiments are examples. Although, the specification refers to one or several embodiments, it does not imply that each reference refers to the same embodiment or that the features apply only to a single embodiment. Simple features of different embodiments can also be combined to provide other embodiments, without departing from the scope of the invention, as defined by the claims.

In the description, some elements may be indexed, for example first element or second element. In this case, it is a simple indexing to differentiate and name similar but not identical elements. This indexing does not imply a priority of one element over another and such names can easily be interchanged without going beyond the scope of the present invention.

In the following, the term “door” is used in its widest sense to indicate any member movable between an open and a closed position to open and close an access opening to an internal compartment of a vehicle, and therefore includes hoods and rear doors, trunks, or front trunks, also known as “frunks”, in addition to the vehicle side doors.

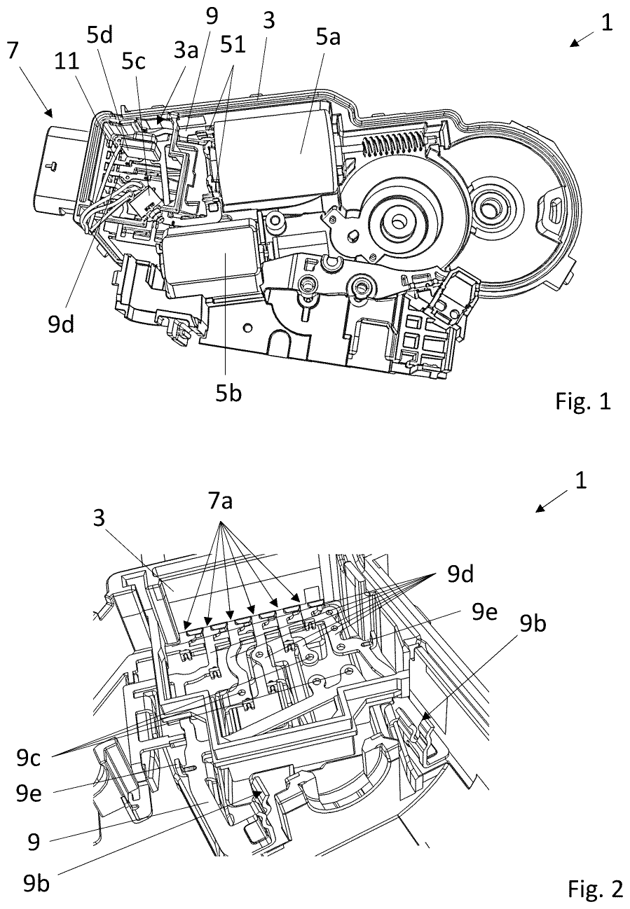

Referring to FIG. 1, the present invention refers to a vehicle door latch 1 configured for ensuring the closing of a vehicle door. The vehicle door latch 1 comprises a housing 3, at least one electrical component 5a, 5b, 5c, 5d, a connector 7 and a leadframe 9 linking the connector 7 to the electrical component 5.

### Connector 7

The connector 7 is configured to be linked to a power supply to supply the at least one electrical component 5a, 5b, 5c, 5d of the vehicle door latch 1. The power supply may be a battery of the vehicle, for example the main battery or a secondary battery dedicated to supply the electrical equipments of the vehicle such as the vehicle door latches 1. The connector 7 may comprise a plurality of pins. The connector 7 may comprise a plurality of holes 7a associated respectively with the plurality of pins. The holes 7a are configured to receive respectively a plurality of leads 9a of the leadframe 9. The pins of the connector 7 may be made by an end of the leads 9a of the leadframe 9 or may be connected to the leads 9a of the leadframe 9. The connector 7 is arranged at an edge of the housing 3 so that a cable can be plugged to the connector 7 to supply power to the vehicle door latch 1. The connector 7 may comprise a part made of plastic material which can be made as one piece with the housing 3.

### Electrical Components 5a, 5b, 5c, 5d

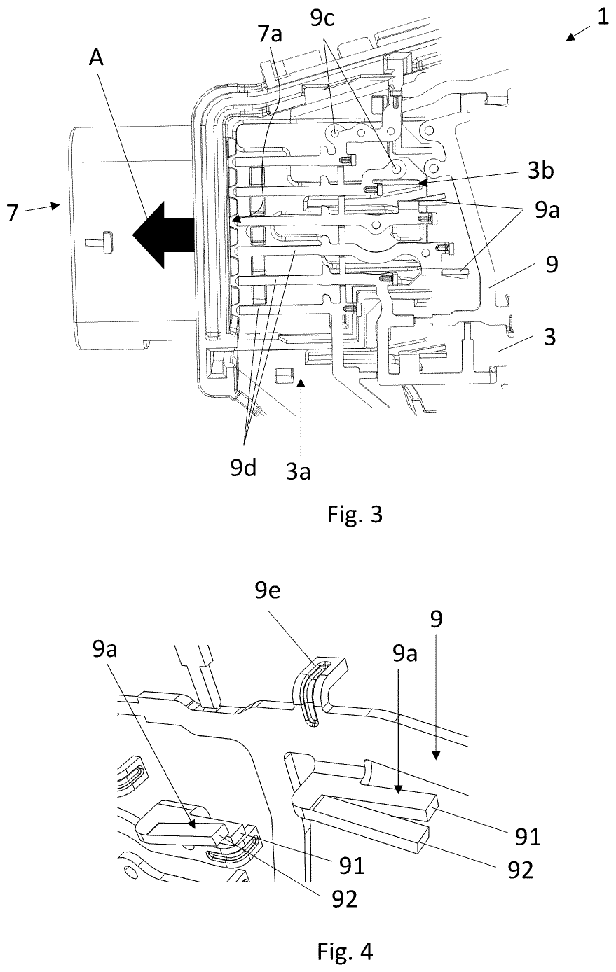

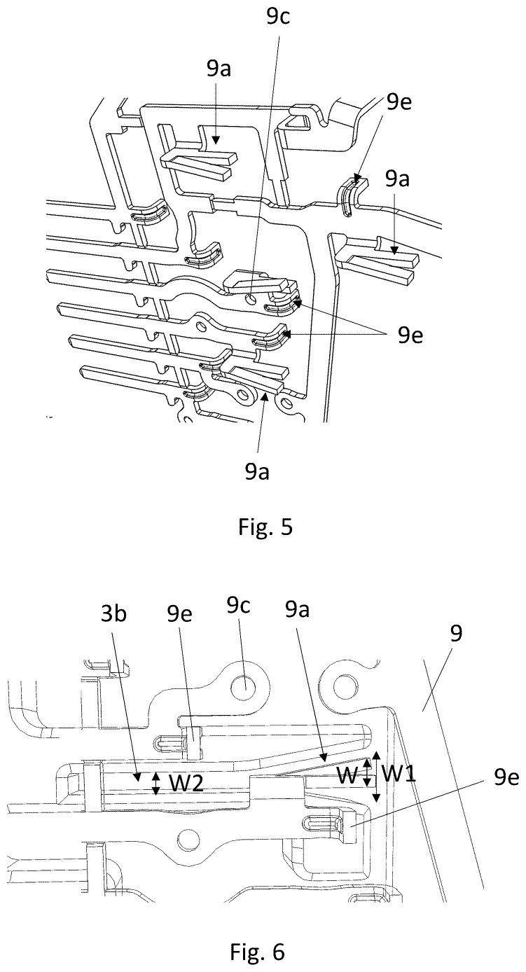

The at least one electrical component 5a, 5b, 5c, 5d may refer to an electrical motor 5a configured for example to ensure the closing of the vehicle door or to an electrical motor 5b configured to release the vehicle door latch 1 (e-release vehicle door latch). Other types of motos may also be supplied by the leadframe such as a locking/unlocking motor of the vehicle door latch 1. The vehicle door latch 1 may also comprise other electrical components, such as switches such as the switch 5c or other components such as a capacitor 5d or sensors of the vehicle door latch 1 that are supplied via the connector 7 and the leadframe 9. The electrical components 5a, 5b, 5c, 5d are configured to be linked, directly and/or via cables 11 to the leadframe 9. For example, the electrical motor 5a may comprise electrical terminals 51 configured to be snapped onto the leadframe 9 for example via snapping elements 9b of the leadframe 9 as represented in FIG. 2. The leadframe 9 may also be configured to extend to internal terminals of the electrical motor 5b. The other components 5c and 5d may be linked to the leadframe by cables 11 linked to holes 9c (more visible in FIG. 2 and FIG. 3) of the leadframe 9. The electrical components 5a, 5b, 5c, 5d may be positioned partially or totally within the housing 3.

### Housing 3

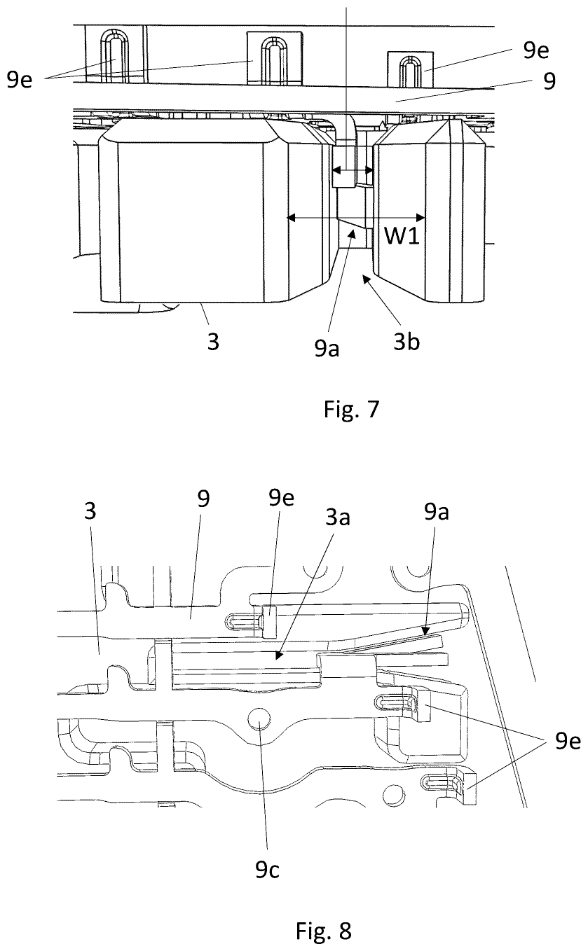

The housing 3 provides a cavity 3a adjacent with the connector 7 and configured to receive the leadframe 9 and at least a part of the at least one electrical component 5a, 5b, 5c, 5d. In the present example, the cavity 3a encloses all the electrical components 5a, 5b, 5c, 5d. The housing 3 may be made of plastic material. As represented in FIG. 6 and FIG. 7, the housing 3 also comprises a plurality of recesses 3b arranged in the cavity 3a and configured for receiving a deformable part 9a of the leadframe 9 to ensure the securing of the leadframe 9 onto the housing 3. The recesses 3b comprise an opening to allow the insertion of the deformable parts 9a of the leadframe 9. The opening of the recess 3b may comprise a convergent shape to ease the insertion of the deformable part 9a of the leadframe 9 within the recess 3b. The convergent shape may also enable a smooth deformation of the deformable part 9a when introduced within the recess 3b. The walls of the opening of the recess 3b may be straight and may correspond to a portion of a funnel. Alternatively, curved walls may also be used. The recesses 3b may be arranged on a common face of the housing 3, for example a bottom part of the cavity 3a. A plurality of recesses 3b may be distributed within the cavity to secure the leadframe 9 to the housing 3 in different locations. Such distribution ensures a reliable securing of the leadframe 9 to the housing 3 and prevents a displacement and a disconnection of the leadframe 9 with respect to the connector 7 and to the electrical components 5a, 5b, 5c, 5d.

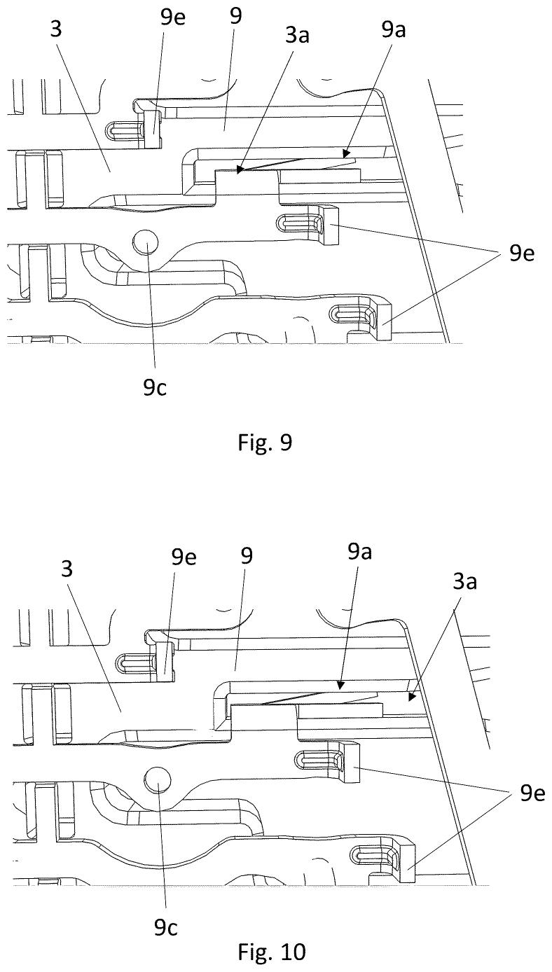

According to the embodiment represented in FIGS. 2 and 3, the recesses 3b comprise a top opening so that the deformable parts 9a of the leadframe 9 may be inserted from the top side, i.e. from the cavity 3a of the housing 3. The opening of the recesses 3b may comprise an enlarged portion with a width w1 larger than the width w of the deformable part 9a of the leadframe 9 (when such deformable part 9a is not introduced in a recess 3b) while the inside part of the recesses 3b is made of a narrow portion with a width w2 smaller than the width w of the deformable part 9a of the leadframe 9. The opening of the recesses 3b also comprise an intermediate portion arranged between the enlarged portion and the narrow portion, the intermediate portion having a convergent shape to provide a smooth transition from the enlarged portion to the narrow portion. Thus, a deformable part 9a may be introduced from the top side into the enlarged portion without being deformed. FIG. 6 represents a deformable part 9a located in the enlarged portion of the opening of the recess 3b. The leadframe 9 may then be slid laterally as represented by the arrow A in FIG. 3 so that the deformable parts 9a are displaced towards the narrow portion of the inside of the recesses 3b. FIGS. 8 and 9 represents the deformable part 9a in the intermediate portion of the opening of the recess 3b with a convergent shape during the sliding of the leadframe 9. Due to the convergent shape of the intermediate portion, the deformable part 9a comes in contact with the wall of the intermediate portion and is therefore deformed to comply with the reducing width of the recess 3b along the intermediate portion and is finally inserted in the narrow portion of the recess 3b to abut to a bottom of the recess 3a as represented in FIG. 10.

### Leadframe 9

The leadframe 9 is arranged within the housing 3. The leadframe 9 may be made of an electrical conductive material such as copper or platted alloy, for example copper-alloy or iron-nickel alloy such as alloy 42. Some portions of the leadframe 9 may also be made of other materials. The leadframe 9 may extend mainly in a main plane configured to extend parallel to a bottom portion of cavity 3a of the housing 3 when the leadframe 9 is secured to the housing 3. The leadframe 9 may comprise a plurality of leads 9d (better visible in FIG. 3) configured to be introduced respectively in the holes 7a of the connector 7. In the example presented in the figures, the leadframe 9 comprises six leads 9d configured to be introduced within the six holes 7a of the connector 7 as represented in FIG. 2. In the present example, the leads 9d also form the pins of the connector 7 configured to be in contact with associated terminals of a cable configured to be plugged in the connector 7. The leads 9d may extend parallel to each other. The leadframe 9 may also comprise snapping ends 9b configured to receive electrical terminals 51 of an electrical component 5a, 5b, 5c, 5d such as the electrical motor 5a. The leadframe 9 may also comprise holes 9c configured to receive a leg of an electrical component 5a, 5b, 5c, 5d or a cable 11 linked to an electrical component 5a, 5b, 5c, 5d. The leadframe 9 may also comprise one or several legs 9e extending out from the main plane. The legs 9e may extend perpendicular to the main plane of the leadframe 9 to provide pushing zones that can be handled to position and to push the leadframe 9 in a direction parallel to the main plane. Additional legs 9e may be used to handle the leadframe 9 or to ensure its positioning within the cavity 3a. The leadframe also comprises at least one deformable parts 9a complementary with the recess 3b of the housing 3. The leadframe 9 may therefore comprise a plurality of deformable parts 9a distributed across the leadframe 9. The deformable parts 9a are configured to be inserted respectively within the recesses 3b of the housing 3 to secure the leadframe 9 to the housing 3. The deformable parts 9a are configured to be deformed elastically when inserted within the recesses 3b. The deformable parts 9a may be made in one piece with the leadframe 9 and may therefore made of the same material as the leadframe. According to the embodiment presented in the figures, the deformable part 9a has a V-shape with a first arm 91 and a second arm 92 linked together at a proximal end as better visible in FIG. 4. The deformable parts 9a may extend perpendicular to the main plane of the leadframe 9 with one arm 91, 92 arranged on top of the other 92, 91. The V-shape may be obtained by bending one of the arms 91, 92. Alternatively, both arms 91, 92 may be bent to provide the V-shape. The width w of the deformable part 9a (between the distal end of the first arm 91 and the second arm 92) is larger than the width w2 of the inside of the recesses 3b corresponding to the narrow portions. As a consequence, the deformable part 9a needs to be deformed to be inserted in a recess 3b. The deformation refers to the distal end of both legs coming closer to each other. Such deformation may be obtained by the bending of one arm 91, 92 towards the other 92, 91 or by the bending of both arms 91 and 92 towards each other. Furthermore, the distal end of the first arm 91 and of the second arm 92 may comprise a sharp shape configured to hook on the wall of the recess 3b when the deformable part 9a is inserted in the recess 3b. The sharp shape refers especially to the edge of the distal end of the first arm 91 and of the second arm 92 which is arranged opposite to the other arm 91, 92. Indeed, it is this edge that is configured to come in contact with a wall of the recess 3b. A sharp shape may refer to an edge between two faces forming an angle of 90° or less. Alternatively, the sharp shape may refer to gripping elements such as a series of spikes or any other sharp shape enabling the deformable part to hook on the wall of the recess 3b. The sharp shape may be configured to prevent the pulling of the deformable part 9a out of the recess 3b and therefore to prevent the displacement of the leadframe 9 with respect to the housing 3 after insertion of the deformable parts 9a within the recesses 3b.

Thus, the use of a leadframe 9 with deformable parts 9a made of a V-shape with two arms configured to come closer to each other when the deformable part 9a is introduced in the recess of the housing 3 enables securing the leadframe 9 to the housing 3 only by sliding the leadframe laterally to introduce the deformable parts 9a within the recesses 3b. Such deformable part 9a may be easily manufactured as they only required the bending of one of the arms 91, 92 of the V-shape. Furthermore, with the use of a sharp shape at the distal end of the arms 91, 92 of the V-shape, the displacement of the leadframe 9 with respect to the housing 3 after the insertion of the deformable parts 9a within the recesses 3b may be prevented.

### Assembling Method

The present invention also refers to a method for assembling a vehicle door latch 1 as described previously.

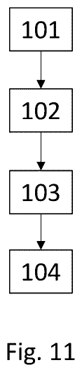

FIG. 11 represents a flowchart of the steps of the method.

The first step 101 refers to the provision of a housing 3 comprising at least one recess 3b and a leadframe 9 comprising at least one deformable part 9a complementary with the recess 3b so that the deformable part 9a may be inserted into the recess 3b. Preferably, the deformable part 9a is elastically deformed when inserted in the recess 3b. The housing 3 may be made of plastic material and may be obtained by injection molding. The at least one recess 3b may be made in a bottom part of a cavity 3a of the housing 3. The bottom part of the cavity 3a may be essentially flat and may define a plane. The leadframe 9 may be made of copper or platted alloy. The leadframe 9 may comprise a plurality of leads 9d linked by non-conductive linking elements. Alternatively, the connecting elements can be conductive, in which case they are cut after assembly so that no current or signals can pass through the connecting elements. The leadframe 9 may extend mainly in a main plane configured to extend parallel to the bottom part of the cavity 3a when secured to the housing 3.

The second step 102 refers to the positioning of the leadframe 9 next to the housing 3 to place the at least one deformable part 9a respectively in front of an opening of the at least one recess 3b. Such step may be done manually or by a robot. The leadframe 9 is for example introduced within a cavity 3a of the housing from a top side, the main plane of the leadframe 9 being arranged parallel to the bottom part of the cavity 3a. The leadframe 9 may comprise legs 9d that may extend perpendicular to the main plane of the leadframe 9 so that the leadframe 9 may be handled by these legs 9d. The legs 9d may be made in a single piece with the leadframe 9.

The third step 103 refers to the sliding of the leadframe 9 to insert the at least deformable part 9a respectively into the at least one complementary recess 3b. Such sliding may be made laterally, that is to say parallel to the bottom part of the cavity 3a. Such sliding may be made by pushing laterally onto the legs 9d which form pushing zones to ease the sliding of the leadframe 9. Such lateral sliding leads to the deformation of the deformable parts to enable their insertion within the recesses 3b. The sliding may be achieved until the deformable parts 9a reach the bottom of the recesses 3b.

The fourth step 104 refers to the arrangement of the at least electrical component 5a, 5b, 5c, 5d in contact with the leadframe 9. Some electrical components 5a, 5b, 5c, 5d such as the electrical motors 5a, 5b may be secured to the housing 3 so that they are configured to come in contact with the leadframe 9 when secured to the housing 3. Their electrical terminals may also be snapped on the leadframe 9. Alternatively, the electrical components 5a, 5b, 5c, 5d such as the small components 5d, 5d may be linked to the leadframe 9 via cables 11.

Thus, the use of a leadframe 9 with deformable parts 9a configured to be inserted within complementary recesses 3b of the housing 3 enables securing the leadframe 9 to the housing 3 without requesting numerous and tedious steps but only by sliding of the leadframe 9 in the cavity 3a of the housing 3. The assembling method of the vehicle door latch 1 is therefore eased and is faster than with previous assembling methods.

1-12. (canceled)

13. A vehicle door latch for closing a vehicle door, comprising:
a housing;
an electrical component arranged at least partially within the housing;
a connector arranged at an edge of the housing and configured to be linked to a power supply of the electrical component; and
a leadframe arranged within the housing and linking the connector and the electrical component,
wherein the housing comprises a recess and the leadframe comprises a deformable part complementary with the recess of the housing and configured to be inserted within the recess of the housing to secure the leadframe to the housing, the deformable part having a larger width than a width of the recess such that the deformable part is deformed when inserted within the recess.

14. The vehicle door latch according to claim 13, wherein the deformable part is in one piece with the leadframe.

15. The vehicle door latch according to claim 13, wherein the deformable part is configured to deform elastically when inserted within the recess.

16. The vehicle door latch according to claim 13, wherein the recess comprises an opening with a convergent shape to ease the insertion of the deformable part within the recess.

17. The vehicle door latch according to claim 13, wherein the deformable part has a V-shape with a first arm and a second arm linked by a proximal end wherein at least one of the first and second arms is configured to be bent towards an other of the first and second arms to reduce the width of the deformable part when introduced within the recess.

18. The vehicle door latch according to claim 17, wherein a distal end of the first arm and the second arm of the deformable part has a sharp shape configured to hook on a wall of the recess when the deformable part is inserted in the recess.

19. The vehicle door latch according to claim 13, wherein the leadframe is made of copper or of platted alloy.

20. The vehicle door latch according to claim 13, wherein the housing is made of plastic material.

21. The vehicle door latch according to claim 13, wherein the electrical component is an electrical motor.

22. The vehicle door latch according to claim 13, wherein the deformable part is configured to be slid within the recess, and wherein the leadframe also comprises a leg configured to provide a pushing zone to allow sliding of the leadframe.

23. The vehicle door latch according to claim 13, wherein the leadframe comprises a plurality of deformable parts distributed across the leadframe and the housing comprises a plurality of recesses configured to receive respectively the plurality of deformable parts.

24. A method for assembling the vehicle door latch according to claim 13, the method comprising the following steps:
providing the housing with the recess and providing the leadframe with the deformable part;
positioning the leadframe next to the housing so that the deformable part is located in front of an opening of the recess;
sliding laterally the leadframe to insert the deformable part into the recess; and
arranging the electrical component in contact with the leadframe.
